(19) United States
(12) Patent Application Publication
(10) Pub. No.: US 2007/0260761 A1
(43) Pub. Date: Nov. 8, 2007

(54) Inter-module data communication control method and system for ACPI and BIOS

(75) Inventor: Ying-Chih Lu, Taipei (TW)

Correspondence Address: FULBRIGHT AND JAWORSKI LLP, 555 S. FLOWER STREET, 41ST FLOOR, LOS ANGELES, CA, 90071, US

(73) Assignee: INVENTEC CORPORATION

(21) Appl. No.: 11/391,786

(22) Filed: Mar. 28, 2006

(51) Int. Cl. G06F 3/00

(52) U.S. Cl. 710/8

(57) ABSTRACT

An inter-module data communication control method and system for ACPI (Advanced Configuration and Power Interface) and BIOS (Basic Input/Output System) is proposed, which is designed for use with a computer platform for providing an inter-module data communication control mechanism, which is characterized by the use of SMI (System Management Interrupt) for the ACPI to communicate with the BIOS of the computer platform. This feature allows BIOS engineers to modify or upgrade ACPI functionality without having to modify any ASL/AML (ACPI Source Language, ACPI Machine Language) code, such that the ACPI development can be more convenient and efficient than prior art. Moreover, it also allows the ASL/AML code for ACPI drivers to have cross-platform capability, which makes programming much easier than prior art

### BACKGROUND OF THE INVENTION

1. Field of the Invention

This invention relates to information technology (IT), and more particularly, to an inter-module data communication control method and system which is designed for use in conjunction with a computer platform of the type having a BIOS (Basic Input/Output System) module and an ACPI (Advanced Configuration and Power Interface) module, where the BIOS module supports SMI (System Management Interrupt), for providing an inter-module data communication control function that allows the ACPI module to communicate with the BIOS module.

2. Description of Related Art

ACPI (Advanced Configuration and Power Interface) is a high performance computer configuration and power management technology which is now widely utilized on various types of computer platforms, including network servers, desktop computers, and notebook computers, for efficient power management on the computer platform.

In the development of ACPI functionalities related to BIOS support, ASL (ACPI Source Language) is the utilized computer language. In actual use, the ASL source code should be complied into machine code, called AML (ACPI Machine Language), for embedding to flash ROM (Read-Only Memory).

In actual operation, the ACPI driver module often needs to communicate with the BIOS (Basic Input/Output System) module, particularly with the POST (Power On Self Test) routine, for exchanging some power management related data. In practice, however, since BIOS code is mostly written in C language (or Assembly Language), the development of ACPI functionalities related to BIOS support requires the BIOS engineers to use C (or Assembly Language) to write related BIOS code and use ASL to write related ACPI routines. Since C (or Assembly Language) differs significantly in syntax from ASL, it often cause trouble to the BIOS engineers in the development of ACPI functionalities. Moreover, when the ACPI or BIOS functionality needs to be modified or upgraded, the BIOS engineers not only need to rewrite related BIOS code, but also has to rewrite related ASL code, which is undoubtedly very tedious, laborious, and time consuming for the BIOS engineers to implement. Moreover, since ASL/AML code is hardware-specific, i.e., it can only work with particular type of chip or hardware, the ASL/AML code lacks cross-platform capability.

### SUMMARY OF THE INVENTION

It is therefore an objective of this invention to provide an inter-module data communication control method and system for ACPI and BIOS which allows BIOS engineers to modify or upgrade ACPI functionality without having to rewrite any ASL/AML code, such that the ACPI development is more convenient and efficient than prior art.

It is another objective of this invention to provide an inter-module data communication control method and system for ACPI and BIOS which allows the ASL/AML code for ACPI drivers to have cross-platform capability.

The inter-module data communication control method and system according to the invention is designed for use in conjunction with a computer platform of the type having a BIOS module and an ACPI module, where the BIOS module supports SMI (System Management Interrupt), for providing an inter-module data communication control function that allows the ACPI module to communicate with the BIOS module.

In conception, the inter-module data communication control method according to the invention comprises: (1) responding to each request issued via system management interrupt from the configuration and power management module by generating a corresponding enabling message, in such a manner that if the configuration and power management module issues a data read request via system management interrupt, issuing a data read enabling message; if the configuration and power management module issues a data transfer request via system management interrupt, issuing a data transfer enabling message and if the configuration and power management module issues a function request via system management interrupt, issuing a function enabling message; (2) responding to the data read enabling message by performing a data reading procedure for reading a set of requested configuration data from a configuration data storage memory area of the startup control module and then transferring the configuration data to the configuration and power management module; (3) responding to the data transfer enabling message by performing a data transferring procedure for transferring a set of data from the configuration and power management module to the startup control module; and (4) responding to the function enabling message by performing a function activating procedure for activating the startup control module to perform a requested function.

In architecture, the inter-module data communication control system is based on an object-oriented component model which comprises: (A) a system management interrupt responding module, which is capable of responding to each request issued via system management interrupt from the configuration and power management module by generating a corresponding enabling message, in such a manner that if the configuration and power management module issues a data read request via system management interrupt, the system management interrupt responding module responsively issues a data read enabling message; if the configuration and power management module issues a data transfer request via system management interrupt, the system management interrupt responding module responsively issues a data transfer enabling message and if the configuration and power management module issues a function request via system management interrupt, the system management interrupt responding module responsively issues a function enabling message; (B) a data reading module, which is capable of responding to the data read enabling message from the system management interrupt responding module by performing a data reading procedure for reading a set of requested configuration data from a configuration data storage memory area of the startup control module and then transferring the configuration data via the system management interrupt responding module to the capable of responding to the data transfer enabling message from the system management interrupt responding module by performing a data transferring procedure for transferring a set of data from the configuration and power management module to the startup control module; and (D) a function activating module, which is capable of responding to the function enabling message from the system management interrupt responding module by performing a function activating procedure for activating the startup control module to perform a requested function.

The inter-module data communication control method and system according to the invention is characterized by the use of SMI (System Management Interrupt) for ACPI to communicate with BIOS. This feature allows BIOS engineers to modify or upgrade ACPI functionality without having to modify any ASL/AML code, such that the ACPI development is more convenient and efficient than prior art. Moreover, it also allows the ASL/AML code for ACPI drivers to have cross-platform capability, which makes programming much easier than prior art.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application of the inter-module data communication control system for ACPI and BIOS according to the invention; and

FIG. 2 is a schematic diagram showing an object-oriented component model of the inter-module data communication control system of the invention.

### DETAILED DESCRIPTION OF PREFERRED EMBODIMENTS

The inter-module data communication control method and system for ACPI and BIOS according to the invention is disclosed in full details by way of preferred embodiments in the following with reference to the accompanying drawings.

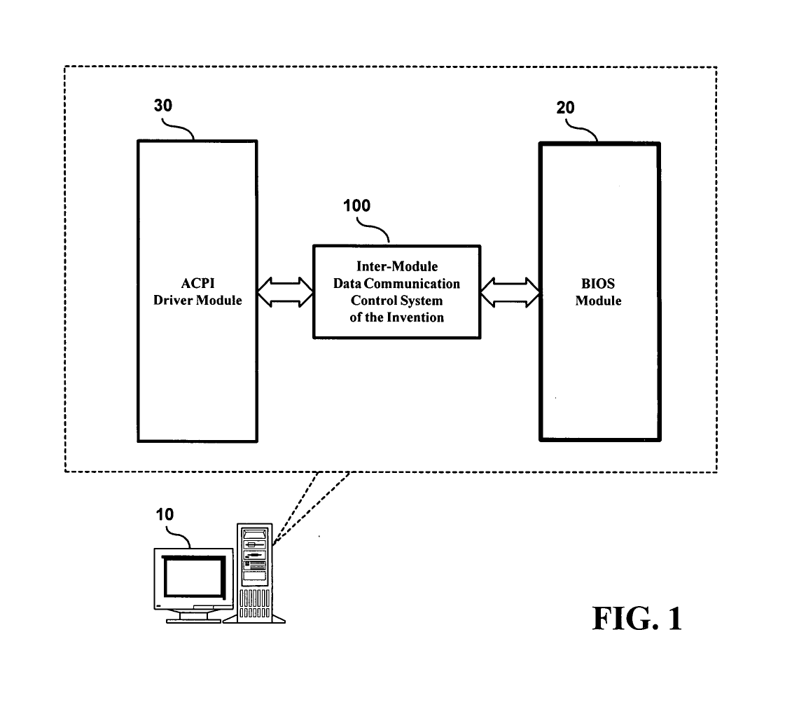

FIG. 1 is a schematic diagram showing the application of the inter-module data communication control system according to the invention (which is here encapsulated in a block indicated by the reference numeral 100). As shown, the inter-module data communication control system of the invention 100 is designed for use in conjunction with a computer platform 10, such as a network server, a desktop computer, or a notebook computer, that is equipped with a startup control module 20 and a configuration and power management module 30; where the startup control module 20 is for example a BIOS (Basic Input/Output System) module, while the configuration and power management module 30 is for example an ACPI (Advanced Configuration and Power Interface) module.

In actual operation, the inter-module data communication control system of the invention 100 is capable of providing an inter-module data communication control mechanism for the ACPI module 30 to communicate with the BIOS module 20. For example, the ACPI module 30 can utilize the inter-module data communication control system of the invention 100 to read a set of configuration data from the BIOS module 20, such as enabled/disabled settings about COM-A/B, PS2-KB/MS, flop diskette drives, parallel ports, to name just a few; transfer a set of data, such as the name of the currently-used operating system, to the BIOS module 20; and activate the BIOS module 20 to perform a certain function, such as enabling PS2-KB/MS Wakeup, enabling Wakeup-On-LAN, enabling Wakeup-On-Ring, clearing wakeup status flags, turning off fan units, setting power indicator (LED) status, notifying current system power state (S0, S1, S2, S3, S4, or S5) to BMC (Baseboard Management Controller) module, to name just a few.

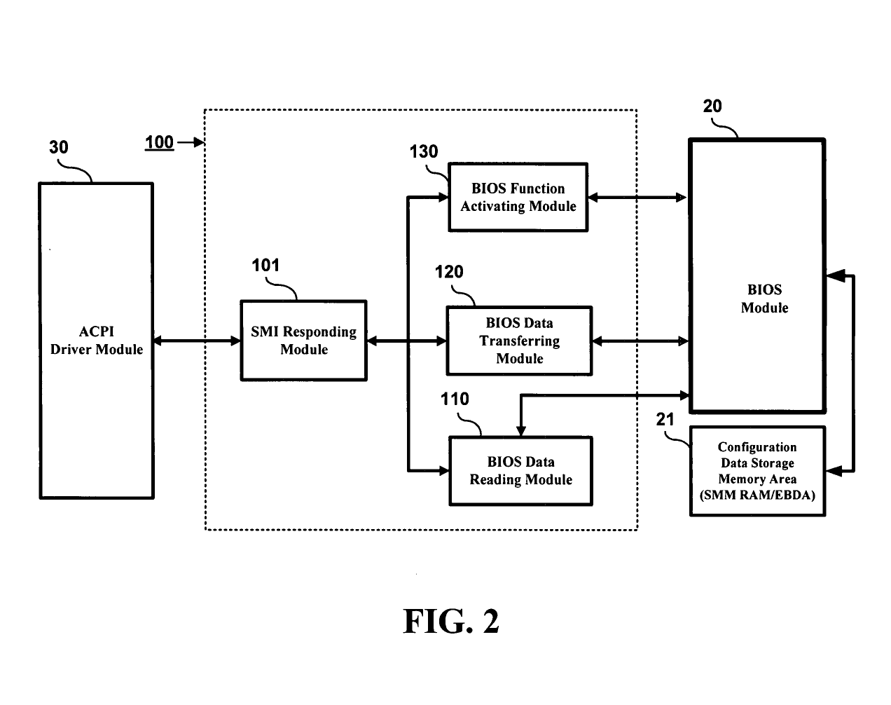

As shown in FIG. 2, in architecture, the inter-module data communication control system of the invention 100 is based on an object-oriented component model which comprises: (A) an SMI responding module 101; (B) a BIOS data reading module 110; (C) a BIOS data transferring module 120; and (D) a BIOS function activating module 130. In practical implementation, the inter-module data communication control system of the invention 100 can be fully realized by computer code and integrated as an add-on firmware module to an SMI (System Management Interrupt) handler embedded in the BIOS (Basic Input/Output System) of the computer platform 10, such that the communication between the ACPI module 30 and the BIOS module 20 can be carried out entirely via SMI messages, such as software SMI messages and sleep-type SMI messages.

Firstly, the respective attributes and behaviors of these constituent components 101, 110, 120, 130 of the inter-module data communication control system of the invention 100 are described in details in the following.

The SMI responding module 101 is capable of responding to each request issued in the form of a SMI signal from the ACPI module 30 by generating a corresponding enabling message. More specifically, if the ACPI module 30 issues a BIOS data read request via SMI, the SMI responding module 101 will responsively issue a BIOS data read enabling message to the BIOS data reading module 110; if the ACPI module 30 issues a BIOS data transfer request via SMI, the SMI responding module 101 will responsively issue a BIOS data transfer enabling message to the BIOS data transferring module 120; and if the ACPI module 30 issues a BIOS function request via SMI, the SMI responding module 101 will responsively issue a BIOS function enabling message to the BIOS function activating module 130. In practical implementation, for example, the standard ASL programming language includes a set of instructions for SMI calls, which have a generalized form as follows:
CALL_SMI(Command, Input Data, Output Data)

where “Command” represents the function being requested, “Input Data” represents a set of data to be transferred to the BIOS module 20, and “Output Data” represents the output data from the BIOS module 20. It is to be noted that this SMI call format is only intended for demonstration; in practice, SMI calls may have other variations in format.

The BIOS data reading module 110 is capable of responding to the BIOS data read enabling message from the SMI responding module 101 by performing a BIOS data reading procedure for reading a set of requested configuration data from a configuration data storage memory area 21 in the BIOS module 20 and then transferring the configuration data via the SMI responding module 101 to the ACPI module 30. In practical implementation, for example, the configuration data storage memory area 21 can be either an SMM-RAM (System Management Mode, Random-Access Memory) memory area, or an EBDA (Extended BIOS Data Area) memory area. At the startup of the computer platform 10, the BIOS module 20 will perform a POST (Power On Self Test) procedure, which detects the current system configuration of the computer platform 10, such as the configuration of COM-A/B, PS2-KB/MS, flop diskette drives, parallel ports, and so on, and then store the configuration data into the configuration data storage memory area 21. Therefore, the BIOS data reading module 110 is designed to gain access to the configuration data storage memory area 21 for retrieving the configuration data stored therein and then transferring the retrieved configuration data to the ACPI module 30.

The BIOS data transferring module 120 is capable of responding to the BIOS data transfer enabling message from the SMI responding module 101 by performing a BIOS data transferring procedure for transferring a set of data from the ACPI module 30 to the BIOS module 20. This mechanism allows the ACPI module 30 to transfer data to the BIOS module 20.

The BIOS function activating module 130 is capable of responding to the BIOS function enabling message from the SMI responding module 101 by performing a BIOS function activating procedure for activating a built-in function of the BIOS module 20, such as enabling PS2-KB/MS Wakeup, enabling Wakeup-On-LAN, enabling Wakeup-On-Ring, clearing wakeup status flags, turning off fan units, setting power indicator (LED) status, notifying current system power state (S0, S1, S2, S3, S4, or S5) to BMC (Baseboard Management Controller) module, to name just a few. This mechanism allows the ACPI module 30 request the BIOS module 20 to perform some functions that are unsuitable for handling by the ACPI module 30. For example, before the computer platform 10 enters sleep mode, there are two temporal points where the involved tasks in the BIOS module 20 must be invoked by the ACPI module 30. The first temporal point is during the execution of ACPI's _PTS method, while the second temporal point is the termination of the switching to S1-S5 mode for the system hardware of the computer platform 10. When the computer platform 10 exits the sleep mode, the ACPI's _WAK method (for wakeup from S1-S5 sleep mode) must invoke the involved procedures in the BIOS module 20.

The following is a detailed description of a practical application example of the inter-module data communication control system of the invention 100 during actual operation.

Referring to FIG. 1 together with FIG. 2, in actual operation, whenever the ACPI module 30 wants to read the current configuration data about the computer platform 10 from the BIOS module 20 (i.e., the configuration data collected by the BIOS module 20 during POST), the ACPI module 30 can simply issue a BIOS data read request in the form of an SMI signal to the inter-module data communication control system of the invention 100. In response, the SMI responding module 101 in the inter-module data communication control system of the invention 100 is activated to issue a BIOS data read enabling message to the BIOS data reading module 110, thereby activating the BIOS data reading module 110 to perform a BIOS data reading procedure for reading the requested configuration data from the configuration data storage memory area 21 of the BIOS module 20, and then transferring the configuration data via the SMI responding module 101 to the ACPI module 30.

Further, whenever the ACPI module 30 wants to transfer a set of data to the BIOS module 20, the ACPI module 30 can simply issue a BIOS data transfer request in the form of an SMI signal to the inter-module data communication control system of the invention 100. In response, the SMI responding module 101 is activated to issue a BIOS data transfer enabling message to the BIOS data transferring module 120, thereby activating the BIOS data transferring module 120 to perform a BIOS data transfer procedure for transferring the data from the ACPI module 30 to the BIOS module 20.

Moreover, when the ACPI module 30 wants to request the BIOS module 20 to perform a certain task, the ACPI module 30 can simply issue a BIOS function request in the form of an SMI signal to the inter-module data communication control system of the invention 100. In response, the SMI responding module 101 is activated to issue a BIOS function enabling message to the BIOS function activating module 130, thereby activating the BIOS function activating module 130 to perform a BIOS function activating procedure for activating the BIOS module 20 to perform a requested function, such as enabling PS2-KB/MS Wakeup, enabling Wakeup-On-LAN, enabling Wakeup-On-Ring, clearing wakeup status flags, turning off fan units, setting power indicator (LED) status, notifying current system power state (S0, S1, S2, S3, S4, or S5) to BMC (Baseboard Management Controller) module, and so on.

In practical implementation, the inter-module data communication control system of the invention 100 can be fully realized by computer code. This allows the ASL/AML code interpreted by the ACPI driver to have a cross-platform capability, i.e., the ACPI driver can run on computer platforms equipped with different types of control chips and hardware configurations, without having to modify its ASL/AML code. Moreover, in order to allow the ACPI module to have cross-platform capability, the associated ASL/AML code that is related to chipset modules, such as Northbridge, Southbridge, SIO (Super Input/Output), and BMC (Baseboard Management Controller), can be removed from ACPI. Instead, they can be now entirely performed by the BIOS module 20. This feature allows the development of the ACPI program code to be significantly easier than the prior art.

In conclusion, the invention provides an inter-module data communication control method and system for use with a computer platform for providing an inter-module data communication control mechanism, which is characterized by the use of SMI (System Management Interrupt) for ACPI to communicate with BIOS. This feature allows BIOS engineers to modify or upgrade ACPI functionality without having to modify any ASL/AML code, such that the ACPI development can be more convenient and efficient than prior art. Moreover, it also allows the ASL/AML code for ACPI drivers to have cross-platform capability, which makes programming much easier than prior art. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. An inter-module data communication control method for use on a computer platform of the type having a startup control module and a configuration and power management module for providing an inter-module data communication control function for the configuration and power management module to communicate with the startup control module, which comprises;
responding to each request issued via system management interrupt from the configuration and power management module by generating a corresponding enabling message, in such a manner that if the configuration and power management module issues a data read request via system management interrupt, issuing a data read enabling message; if the configuration and power management module issues a data transfer request via system management interrupt, issuing a data transfer enabling message and if the configuration and power management module issues a function request via system management interrupt, issuing a function enabling message;
responding to the data read enabling message by performing a data reading procedure for reading a set of requested configuration data from a configuration data storage memory area of the startup control module and then transferring the configuration data to the configuration and power management module;
responding to the data transfer enabling message by performing a data transferring procedure for transferring a set of data from the configuration and power management module to the startup control module; and
responding to the function enabling message by performing a function activating procedure for activating the startup control module to perform a requested function.

2. The inter-module data communication control method of claim 1, wherein the computer platform is a network server.

3. The inter-module data communication control method of claim 1, wherein the computer platform is a desktop computer.

4. The inter-module data communication control method of claim 1, wherein the

5. The inter-module data communication control method of claim 1, wherein the startup control module is a BIOS (Basic Input/Output System) module, while the configuration and power management module is an ACPI (Advanced Configuration and Power Interface) module.

6. The inter-module data communication control method of claim 1, wherein the configuration data storage memory area is an SMM-RAM (System Management Mode, Random-Access Memory) memory area.

7. The inter-module data communication control method of claim 1, wherein the configuration data storage memory area is an EBDA (Extended BIOS Data Area) memory area.

8. An inter-module data communication control system for use with a computer platform of the type having a startup control module and a configuration and power management module for providing an inter-module data communication control function for the configuration and power management module to communicate with the startup control module, which comprises:
a system management interrupt responding module, which is capable of responding to each request issued via system management interrupt from the configuration and power management module by generating a corresponding enabling message, in such a manner that if the configuration and power management module issues a data read request via system management interrupt, the system management interrupt responding module responsively issues a data read enabling message; if the configuration and power management module issues a data transfer request via system management interrupt, the system management interrupt responding module responsively issues a data transfer enabling message and if the configuration and power management module issues a function request via system management interrupt, the system management interrupt responding module responsively issues a function enabling message;
a data reading module, which is capable of responding to the data read enabling message from the system management interrupt responding module by performing a data reading procedure for reading a set of requested configuration data from a configuration data storage memory area of the startup control module and then transferring the configuration data via the system management interrupt responding module to the configuration and power management module;
a data transferring module, which is capable of responding to the data transfer enabling message from the system management interrupt responding module by performing a data transferring procedure for transferring a set of data from the configuration and power management module to the startup control module; and
a function activating module, which is capable of responding to the function enabling message from the system management interrupt responding module by performing a function activating procedure for activating the startup control module to perform a requested function.

9. The inter-module data communication control system of claim 8, wherein the computer platform is a network server.

10. The inter-module data communication control system of claim 8, wherein the computer platform is a desktop computer.

11. The inter-module data communication control system of claim 8, wherein the computer platform is a notebook computer.

12. The inter-module data communication control system of claim 8, wherein the startup control module is a BIOS (Basic Input/Output System) module, while the configuration and power management module is an ACPI (Advanced Configuration and Power Interface) module.

13. The inter-module data communication control system of claim 8, wherein the configuration data storage memory area is an SMM-RAM (System Management Mode, Random-Access Memory) memory area.

14. The inter-module data communication control system of claim 8, wherein the configuration data storage memory area is an EBDA (Extended BIOS Data Area) memory area.

15. The inter-module data communication control system of claim 8, which is implemented in a firmware program for integration to a BIOS (Basic Input/Output System) module's SMI (System Management Interrupt) handler.
